(19) United States
(12) Patent Application Publication
(10) Pub. No.: US 2009/0081943 A1
(43) Pub. Date: Mar. 26, 2009

(54) SYSTEM AND METHOD FOR NEAR FIELD COMMUNICATIONS HAVING LOCAL SECURITY

(75) Inventors: Douglas Howard Dobyns, Lindon, UT (US); Howard Bernard Dobyns, Orem, UT (US); Jed Erich Woodard, Spanish Fork, UT (US); Anthony Joseph Sutera, Midway, UT (US)

Correspondence Address: Jefferson IP Law, LLP, 1730 M Street, NW, Suite 807, Washington, DC, 20036, US

(73) Assignee: RADEUM, INC. DBA FREELINC, Orem, UT (US)

(21) Appl. No.: 12/239,737

(22) Filed: Sep. 26, 2008

Related U.S. Application Data
(60) Provisional application No. 60/975,493, filed on Sep. 26, 2007.

(51) Int. Cl. H04K 3/00

(52) U.S. Cl. 455/1

(57) ABSTRACT

A system and method for near field communications is provided. The system includes a near field generator configured to generate a near field detectable signal comprising information, a near field detector configured to receive the near field detectable signal and output the information, and an Electro-Magnetic (EM) Radio Frequency (RF) jamming transmitter configured to radiate an EM RF jamming signal, in order to jam reception of EM RF signals in the vicinity of at least one of the near field generator and near field detector.

### CROSS-REFERENCE TO RELATED APPLICATION

This application claims the benefit under 35 U.S.C. § 119(e) of a U.S. Provisional application filed on Sep. 26, 2007 in the U.S. Patent and Trademark Office and assigned Ser. No. 60/975,493, the entire disclosure of which is hereby incorporated by reference.

### BACKGROUND

1. Field of the Invention The present invention relates to near field communications. More particularly, the present invention relates to Electro-Magnetic Interference (EMI) and Radio Frequency Interference (RFI) immunity and localized security in a near field communications system.

2. Description of the Related Art

Near field magnetic communication is a form of wireless physical layer communication that transmits information by coupling non-propagating, quasi-static magnetic fields between devices. A desired magnetic field can be created by a generator coil that is measured using a detector coil. The signal modulation schemes often used in Radio Frequency (RF) communications, such as amplitude modulation, phase modulation, and frequency modulation, can be used in near-field magnetic communications systems.

Near-field magnetic communications systems are designed to contain transmission energy within the localized magnetic field. This magnetic field energy resonates near the communications system, but does not generally radiate into free space. This type of transmission is referred to as “near-field.” The power density of near-field transmissions attenuates or rolls off at a rate proportional to the inverse of the range to the sixth power (1/range⁶) or −60 dB per decade.

The use of localized magnetic induction distinguishes near field communications from conventional far-field RF and microwave systems in that conventional wireless RF systems use an antenna to generate and transmit a propagated RF wave. In these types of systems, the transmission energy is designed to leave the antenna and radiate into free space. This type of transmission is referred to as “far-field.” The power density of far-field transmissions attenuates or rolls off at a rate proportional to the inverse of the range to the second power (1/range²) or −20 dB per decade.

One concern in wireless communications systems is the assignment and control of the RF frequency spectrum. As more and more wireless communications devices co-exist, the demand for available frequencies and clear channels becomes greater. Currently, most wireless communications systems rely on a far-field RF physical communication layer. The far-field propagated signals used in these communications systems can travel miles beyond the desired transmission range, causing interference with other wireless systems. To address this interference, each system can increase transmission power or be designed to share much of the same frequency spectrum. This spectrum allocation requires the implementation of complex time and frequency allocation algorithms. However, even with all of these work-around allocation schemes, the RF spectrum is still becoming increasingly crowded. The result is a steadily worsening interference and interoperability problem that simply cannot be addressed by transmitting with more power or moving to more complex and power-intensive frequency-management schemes.

Unlike far-field RF waves, the well defined communication region of magnetic-field energy allows for a large number of near-field magnetic communications systems to be in relatively close proximity while operating on the same frequency. Simultaneous access to a defined frequency spectrum is accomplished by localizing the communication region or spatial allocation and not by the allocation of frequencies or time division.

The fundamental nature of far-field RF communication is to generate a signal and transmit this signal into free space. By design, virtually all of the energy is transmitted into free space with no re-use of transmit power. This is very inefficient from a power usage perspective. In contrast, near field magnetic systems use less power to sustain a non-propagating magnetic field compared to typical radio systems that must continually generate and propagate an electromagnetic wave into free space.

Near-field magnetic communications systems are designed to work in the near-field. The far-field power density of these systems is up to −60 dB less than an equivalent far-field RF device, which is designed to intentionally emit far-field electromagnetic waves. As the distance from an NFMI system increases the emission levels rapidly attenuate below ambient noise floors making detection extremely difficult. This allows for wireless communication with a low probability of detection and a low probability of interception.

In practice, far-field RF signals used in existing wireless systems can be unpredictable, especially in urban environments, where frequency spectrum contention, EMI, fading, reflection, and blocking due to interfering obstacles such as buildings, vehicles, and industrial equipment can significantly reduce the effectiveness of current far-field RF systems. In addition, far-field RF systems are highly susceptible to EMI due to the nature of the antenna configurations that are designed to be sensitive to energy excitement of electromagnetic plane waves. In instances when the EMI is near the carrier frequency of a far-field RF system, the EMI will prevent the RF system from receiving transmissions, as the antenna will receive both the EMI signals and the intended RF signal equally well.

Near-field magnetic energy is contained in a magnetic field, forming a tight communication area that provides a high signal-to-noise ratio between devices. These magnetic fields are highly predictable and less susceptible to fading, reflection, and EMI than RF electromagnetic waves used in current communications systems.

Near field communications systems can be useful in a variety of applications such as audio transmission, video transmission, proximity detection, data transmission, and message signaling. For example, a near field communications system can be used to provide a wireless link between a headset and a radio, such as a public service transceiver, military transceiver, cellular telephone, amateur radio transceiver, or the like. The radio may, for example, be worn on a belt while the headset allows for hand-free operation. The radio itself may be based on near-field communication allowing for wireless communication between individuals, vehicles, electronic devices, or other means associated with radio use.

One concern with wireless systems is providing effective communications in high density Electro-Magnetic Radiation (EMR) environments. While near field communications are inherently short range, sometimes large amounts of RF and other interference can interfere with near-field communication channels. Accordingly, techniques to enhance the effectiveness of near field communications systems are desired.

### SUMMARY

An aspect of the present invention is to address at least the above-mentioned problems and/or disadvantages and to provide at least the advantages described below. Accordingly, an aspect of the present invention is to provide EMI and RFI immunity and localized security in a near field communications system.

In accordance with an aspect of the present invention a near field communications system is provided. The system can include a near field generator configured to generate a near field detectable signal comprising information, a near field detector configured to receive the near field detectable signal and output the information, and an EM RF jamming transmitter configured to radiate an EM RF jamming signal, in order to jam reception of EM RF signals in the vicinity of at least one of the near field generator and near field detector.

In accordance with another aspect of the present, a method for a near field communications system is provided. The method can include forming a magnetic energy field using a near field generator for transmission of information via near field communications, radiating an EM RF jamming signal, in order to jam reception of EM RF signals in the vicinity of at least one of the near field generator and a near field detector, and enabling the near field detector to receive the information via the near field signal when in the vicinity of the EM RF jamming signal.

In accordance with still another aspect of the present, a near field communications system is provided. The system can include a near field generator configured to generate a near field detectable signal comprising information, a near field detector configured to receive the near field detectable signal and output the information, an EM RF jamming transmitter configured to radiate an EM RF jamming signal, in order to jam reception of EM RF signals in the vicinity of at least one of the near field generator and the near field detector, and an EM shield surrounding the near field generator to block EM frequencies from interfering with operations of the near field generator.

In accordance with yet another aspect of the present, a near field communications system is provided. The system can include a near field generator configured to generate a near field detectable signal comprising information, a near field detector configured to receive the near field detectable signal and output the information, an EM RF jamming transmitter configured to radiate an EM RF jamming signal, in order to jam reception of EM RF signals in the vicinity of at least one of the near field generator and the near field detector, and an EM shield surrounding the near field detector to block EM frequencies from interfering with operations of the near field detector and to allow magnetic fields to pass through the EM shield.

In accordance with a further aspect of the present, a near field communications system is provided. The system can include a near field generator configured to generate a near field detectable signal comprising information, a near field detector configured to receive the near field detectable signal and output the information, an EM shield surrounding the near field detector to block EM frequencies from interfering with operations of the near field detector.

In accordance with still a further aspect of the present, a near field communications system is provided. The system can include a near field generator configured to generate a near field detectable signal comprising information, a near field detector configured to receive the near field detectable signal and output the encoded information, and a defeat structure configured to reduce EM frequencies from interfering with operations of at least one of the near field generator and the near field detector.

In accordance with another aspect of the present, a near field communications system is provided. The system includes a near field generator configured to generate a near field detectable signal, and a near field load configured to inductively couple with the near field detectable signal and vary a load which correlates to information to be exchanged, wherein the near field generator can detect the information by monitoring the load created by the near field load, wherein at least one of the near field generator and the near field load receive an Electro-Magnetic (EM) Radio Frequency (RF) jamming signal configured to jam reception of EM RF signals.

Other aspects, advantages, and salient features of the present invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the invention will be more apparent from the description which follows, taken in conjunction with the accompanying drawings, which together illustrate, by way of example, features of the invention; and, wherein:

FIG. 1 is a block diagram illustration of a near field communications system having enhanced security in accordance with an exemplary embodiment of the present invention;

FIG. 2a is a block diagram illustrating a near field communications system having a near field generator with electromagnetic shielding in accordance with an exemplary embodiment of the present invention;

FIG. 2b is a block diagram illustrating a near field communications system having a near field detector with electromagnetic shielding in accordance with an exemplary embodiment of the present invention;

FIG. 3 illustrates a coaxial orientation between two near field systems in accordance with an exemplary embodiment;

FIG. 4 illustrates two near field antennas and the amount of coupling provided by a parallel or orthogonal orientation in accordance with an exemplary embodiment;

FIG. 5 illustrates that as the angular displacement between antennas increases with respect to each other in the same plane, then the voltage excitation in the antenna will drop off as the cos(θ) changes, in accordance with an exemplary embodiment;

FIG. 6 illustrates a plurality of near field communications systems that are able to communicate with one another in accordance with an exemplary embodiment;

FIG. 7 is a block diagram illustrating using a near field generator to generate a magnetic field and an information source to vary a load on the generated field which correlates to the information to be exchanged, in accordance with an exemplary embodiment; and

FIG. 8 is a flow chart illustrating a method of enhancing security of a near field communications system in accordance with an exemplary embodiment of the present invention.

Throughout the drawings, like reference numerals will be understood to refer to like parts, components and structures.

### DETAILED DESCRIPTION OF EXEMPLARY EMBODIMENTS

Reference will now be made to exemplary embodiments of the present invention, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention as defined by the appended claims and their equivalents. In addition, descriptions of well-known functions and constructions are omitted for clarity and conciseness.

It is to be understood that the singular forms “a,” “an,” and “the” include plural referents unless the context clearly dictates otherwise. Thus, for example, reference to “a component surface” includes reference to one or more of such surfaces.

As used herein, the term “about” means that dimensions, sizes, formulations, parameters, shapes and other quantities and characteristics are not and need not be exact, but may be approximated and/or larger or smaller, as desired, reflecting tolerances, conversion factors, rounding off, measurement error and the like and other factors known to those of skill in the art.

By the term “substantially” is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

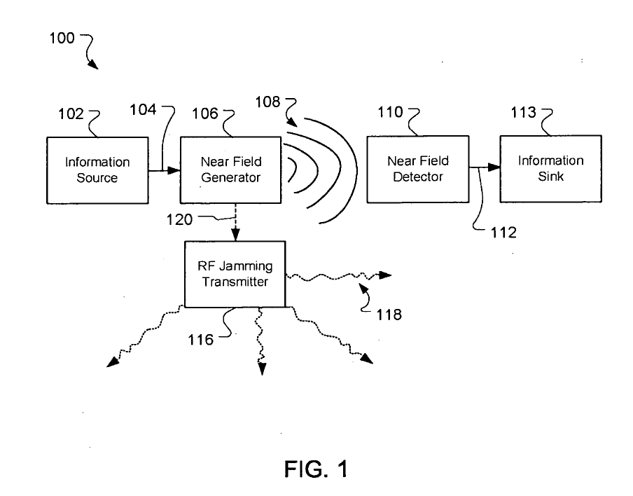

FIG. 1 illustrates a near field communications system in accordance with an exemplary embodiment of the present invention. The near field communications system, shown generally at 100, includes an information source 102 that produces information 104 as an output. The information may be in an analog or digital format. For example, the information may be a continuous analog audio signal, a digitized audio signal, a data sequence, or the like. As a particular example, the information source may include a microphone for converting an acoustic signal into an electric signal, a digitizer, a computer, a camera, a sensor, other electronic equipment, or combinations thereof.

The system includes a means for generating a near field detectable information signal, such as a near field generator 106. The near field generator can generate a near field signal 108 having the information encoded therein. For example, the near field generator may generate a magnetic field. To generate the desired field, the near field generator may include a coil for magnetic induction for generating the near field.

A near field detector 110 can detect or measure the near field 108. For example, the near field detector can magnetically couple with the near field and decode the information encoded in the near field. In the case of Near Field Magnetic Induction (NFMI), the communication link is established by creating, altering and detecting the changes in a magnetic field. The decoded information 112 may be output to an information sink 113. For example, the information sink may include a speaker that converts an electronic signal into an acoustic signal, digital to analog conversion, a personal computer, an image reproduction device, other electronics equipment, or combinations thereof. The near field induction can be used as the physical link in a wireless network and known networking layers can be used on top of the physical link layer.

Near field communications using magnetic coupling can also be used in data communications applications. For example, near field magnetic communication can be used to connect a personal computer, graphical user interface, or laptop to one or more peripheral devices such as a mouse, keyboard, speakers, audio headsets, cameras, microphones, or other data oriented peripherals in a system. Wireless programming of devices can also take place using near field magnetic communication, and configuration data can be sent to a device to change the device's setup. Signaling or switching applications can use near field communications to turn a device on/off or set a device to a simple state (e.g., ready to receive).

In certain situations, the individuals using a near field communications system may desire to block out Radio Frequency (RF) signals in the vicinity while retaining the ability to communicate using the near field system. Blocking RF and similar propagated Electro-Magnetic (EM) signals can also stop counter-military forces from detonating hidden explosive devices, controlling robotic offensive weapons or using other weapons and communication devices that rely on RF and propagated electromagnetic frequencies. The capability to communicate wirelessly using the near field system while blocking other propagated electromagnetic signals in a local area can provide tactical advantages in covert operations or military situations.

For example, Improvised Explosive Devices (IEDs) have been a threat to military checkpoints, convoys, and dismounted operations. In order to combat the challenge of IEDs, the military has used RF jamming equipment. These jamming systems introduce new problems, not the least of which is the challenge for friendly troops to communicate while in a jammed environment. Therefore, exemplary embodiments of the present invention are provided to meet the IED challenge and protect military personnel, while simultaneously providing military personnel with offensive advantages such as communications within and among individual soldiers and air or ground vehicle mounted communications systems.

In the illustrated exemplary embodiment in FIG. 1, the near field system 100 can include a means for jamming a signal, such as a RF jamming transmitter 116 that is configured to radiate a jamming electromagnetic signal 118. The propagated jamming signal is designed to have characteristics of random noise so that actual RF signals and other propagated electromagnetic signals are not distinguishable. For example, the jamming signal may include random pulses, stepped tones, warbler, randomly keyed carrier wave, pulses, recorded sounds in random orders, and the like. The jamming signal is generally uncorrelated with the information being sent between the near field systems. In addition, the jamming signal helps to enhance the security of the near field communications system by making it difficult for an eavesdropper to detect and decode the near-field information.

In one exemplary embodiment, the jamming signal may occupy a wide bandwidth. This can make detection of the near field radiation more difficult because a larger bandwidth needs to be searched in order to even detect the near field radiation. Alternatively, a wideband signal can be used to jam a spectrum containing all the carrier frequencies that may be used by frequency hopping of a carrier frequency.

In another exemplary embodiment, the jamming signal may be configured to occupy substantially the same bandwidth as the near field magnetic radiation or the near field radiation frequency can be contained within the jamming bandwidth. Small differences in bandwidth between the jamming signal and the near field radiation may occur without adversely impacting security, and thus the bandwidths need not be precisely the same.

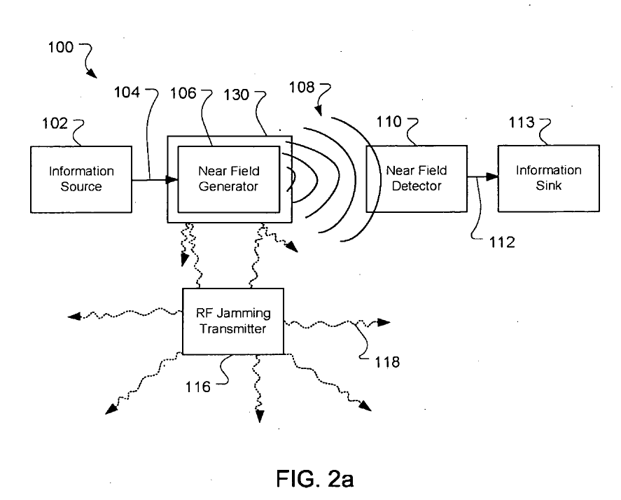

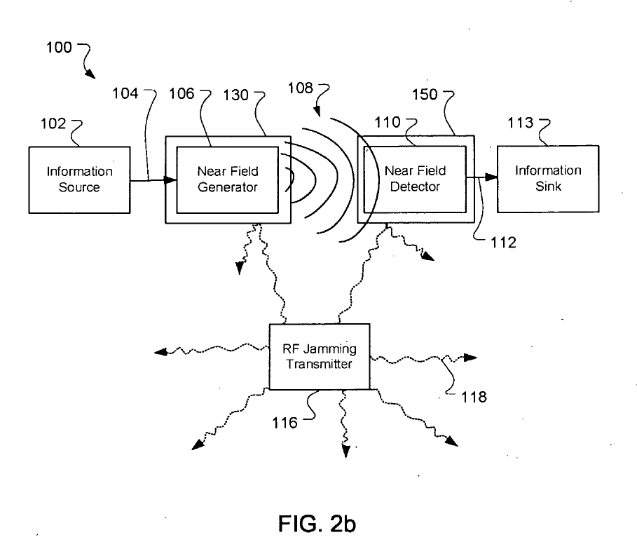

FIG. 2a illustrates that EM shielding 130 can be used as a defeat structure to reduce, block, defeat, or filter out the electromagnetic radiation being produced by other devices including jamming devices. In one exemplary embodiment, an EM shield can be configured to surround the near field generator and/or its near field coil arrays. This blocks EM frequencies and/or RF waves and stops them from interfering with the internal operations of the near field generator.

In an exemplary embodiment illustrated by FIG. 2b, another EM shield 150 can be configured to surround the near field detector and/or its near field coil arrays. This helps block EM frequencies and/or RF waves and stops or reduces the interference with the internal operations of the near field detector. Another example of shielding is where the EM shield is configured to block RF from radios, cell phones, microwaves and similar communication technologies. The shield may be a Faraday cage that blocks the EM signals while allowing magnetic fields to pass through.

In addition, the shielding configuration may be optimized for the specific communications system. For example, antenna diversity can be used in the near field magnetic communications system. In this type of system, each antenna may be individually shielded. In systems with one or more dedicated transmission antennas and one or more dedicated receiver antennas, it may be beneficial to shield only the transmission antennas as a group or only the receiver antennas arrays as a group. In addition, it may be beneficial to shield the entire system or a combination thereof.

The shields may be constructed from materials optimized for the attenuation of EM plane waves while minimizing the attenuation of magnetic fields. For example, shield configurations which reduce magnetic eddy currents due to time varying magnetic flux lines passing through a conductive surface can be minimized by shielding designs with apertures and/or materials preventing the continuous flow of such currents.

In addition to shielding techniques to optimize the functionality of near field magnetic communication within a high field strength RF environment (or a jammed environment), other defeat structures or techniques can be used to minimize near field attenuation and increase the efficiency of the near field magnetic link or magnetic coupling between devices can be used. One example of a defeat structure that can affect the ability of a near field system to communicate in a high field strength RF environment can include certain antenna optimizations.

The efficiency of the magnetic antenna system is proportionally related to the magnetic permeability of the material used in the antenna design. Selecting materials which exhibit maximum permeability at the desired carrier frequency increases the overall receiver efficiency as well as improves front end signal-to-noise ratios, thus increasing the overall receiver sensitivity and extending the potential magnetic link communication distance.

Antenna shape and construction can play a significant role in the efficiency of the near field magnetic antenna system. The cross sectional area and diameter-to-length ratios of the antenna contribute the voltage excitation seen at the terminals of the antenna. In addition to the antenna material and shape, the method for winding the antenna along with the winding shapes and configurations can also contribute to achieving maximum efficiency. Coil winding spacing and placement in relationship to the shape and size of the antennas can greatly affect the efficiency of the antenna system. In addition, techniques for multiple windings and phase alignment can be implemented to further increase the efficiency and sensitivity of the receiver antennas.

Combining multiple antennas with wiring techniques can be used to shape the magnetic field where the flux density is focused in the direction of the poles of the antennas in an effort to extend the range of the magnetic field. These techniques may require additional power but are useful in specific applications.

In magnetic systems, the polarization of the magnetic field is highly dependent on the field source, namely the transducer. A ferrite rod wound with wire is an example of a magnetic field source. While this transducer generates a field typical to that of a classic dipole, the reciprocal properties of magnetic circuits imply that a similarly shaped receiving rod will have an equivalent sensitivity field.

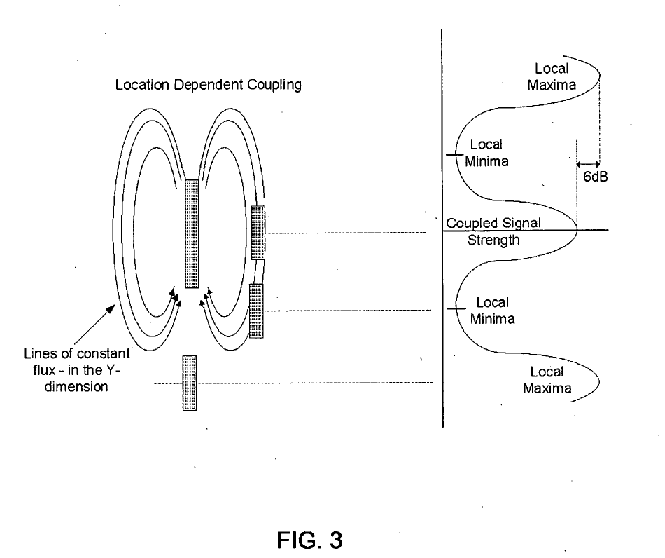

Maximum coupling is achieved when two rods, one a transmitter the other a receiver, point at each other. This is called the coaxial orientation, as illustrated in FIG. 3. Strong coupling can also occur in the coplanar orientation when the rods are parallel to each other.

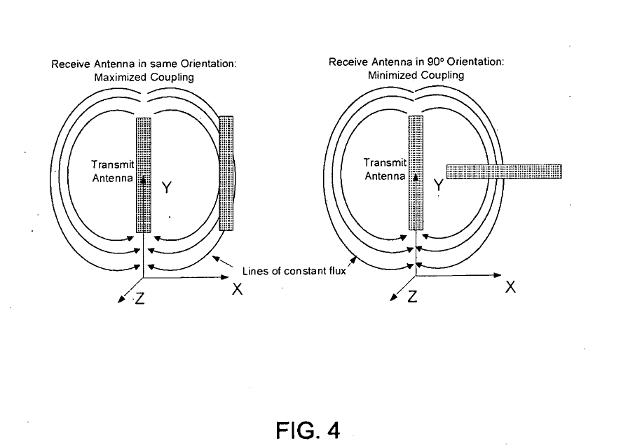

Magnetic field communication is limited by the orthogonal properties of the magnetic fields. The magnetic field produced by an antenna oriented on the Y-axis of a 3 dimensional (XYZ) coordinate system will have a field pattern such that a second antenna oriented in the same Y direction will receive the maximum field strength (at a particular distance), while an antenna oriented on the X or Z plane will receive the minimum signal. The result of orthogonality can be seen in FIG. 4.

The terminal voltage of a magnetic field loop antenna can be expressed as:

V=2πμ₀NAH₀f cos θ

where:

V is the terminal voltage

2πμ0 is a permeability constant

N is the number of turns

A is the loop area (meters2)

H₀ is the applied magnetic field (amperes/meter)

f is the frequency (Hz)

cos θ is the cosine of the angle between the loop axis and the magnetic field

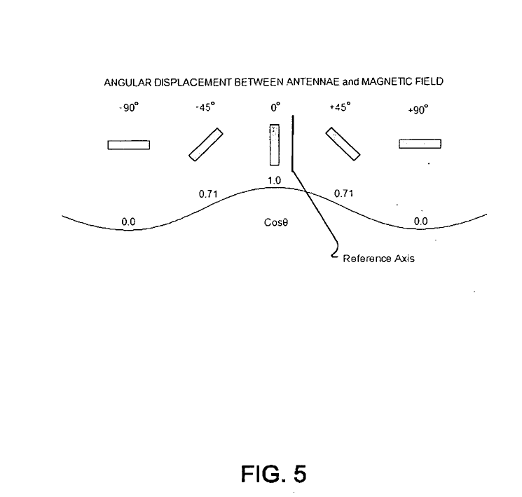

According to this equation, it can be seen that as the angular displacement between antennas and the magnetic field increases with respect to each other in the same plane, then the voltage excitation in the antenna will drop off as the cos(θ) changes from an offset angle of θ to 90°. This displacement is illustrated in FIG. 5.

The relative strength of the coupled signal is proportional to the lines of magnetic flux density that flow through the ends of the ferrite antenna. Polarization diversity should be employed so that substantial coupling occurs regardless of the orientation of the transmitting and receiving transducers. As a result of these orthogonal properties, one exemplary embodiment of a near field system can implement a plurality of antennas mounted in different planes. In one example, three antennas may be oriented at 90 degrees to each other, or one in each of the X, Y and Z planes. Fortunately, since the coupling in magnetic systems is reciprocal, the polarization for optimum reception is identical to the polarization for optimum transmission.

Additional measures can be taken to further reduce the effects of attenuation due to system antenna orientation. When the input signals of multiple antennas are summed, the worse case scenario is an efficiency scalar of one. Any angular displacement from the co-planar orientation will cause an increase in one of the orthogonal antennas as the angle changes from 90 degrees. This system may maximize the achievable magnetic communication link distance by ensuring that aspects of an efficient near field magnetic communications system are not diminished by angular displacement.

In addition to overcoming signal loss due to angular displacement between near field magnetic antennas, and achieving the maximum possible efficiency of near field magnetic coupling between devices, the implementation of antenna diversity is directly advantageous to near field magnetic communication in a harsh EMI environment. There may be instances when the radiated RF jamming signal has intentional planar directivity due to the desired target to be jammed, or unintentional planar directivity due to limitations in the jamming antenna or system. In these instances, certain near field magnetic antennas will have a planar orientation which is more susceptible to the RF jamming signal, while other near field magnetic antennas will be oriented in a planar orientation which is relatively immune to the RF jamming signal. In this situation, the near field magnetic communications system uses antenna diversity to communicate in the planes with the lowest RF interference.

The near field generator may be designed to provide high efficiency for near field generation while providing low efficiency electromagnetic radiation. For example, a loop antenna may be used to generate a magnetic field. The efficiency of the propagated electromagnetic radiation is reduced as the transmitting loop's antenna diameter is decreased as compared to the transmitted frequency modulated through the loop antenna.

In one exemplary embodiment, the jamming signals 118 (FIG. 1) can be radiated with a field strength similar to the near field generator strength. If the jamming signal is too weak relative to the near field magnetic output, the jamming signal may not adequately jam local EM waves. In contrast, a high power jamming signal can provide better jamming, but this may result in undesirable effects such as increased power consumption, and reduced covertness for the near field communications system.

One valuable result of the near field communications system is the relatively low probability of detection of the near field generator at a distance. Low probability of detection is helpful when covertness is desired, such as in a warfare situation. As noted above, the near field falls off at about 60 dB per decade of distance. Detection of the near field communications system at a distance using near field coupling is difficult and may force an adversary to be close or to use a very large detector array. At sufficient distances, detection of the near field can become a practical impossibility due to noise caused by the described jamming and noise sources within the adversary's equipment.

To maximize jamming, a larger signal level for the jamming signal is desired, but to minimize detectability, a smaller signal level for the jamming electromagnetic signal is also desired. Accordingly, providing the near field signal with substantially the same field strength as the jamming signal provides a good compromise between these opposing effects. For example, the jamming field strength may equal the magnetic near field strength to within a few decibels.

Directional differences between the radiation of the jamming signal and the near field signal can result in variations in the relative field strengths at certain positions relative to the near field generator 106. Areas in which the relative field strength of the near field signal is higher may make it easier for an eavesdropper to detect the information in those positions. Of course, depending on the application, such a situation may be acceptable. For example, in ground-based communications, the directions of most concern are in the horizontal direction and radiation in an upward direction, which requires aerial platforms for detection or interception, may be of less concern.

It may be desirable for the jamming signal to be radiated with directivity to jam the transmission of RF signals in certain planes. For example, if the jamming signal is radiated generally in one direction relative to the near field generator, this may better block ground origination RF signals. As a particular example, in a magnetic induction system, the near field can be generated using a coil. Then the jamming signal may be radiated using a small dipole or bowtie antenna. Accordingly, it may be helpful to align the antenna used to radiate the jamming signal appropriately to match the expected incoming RF signals that are desired to be jammed.

The signal level of the jamming signal may be selected so that the total propagated energy is less than a defined level at a defined distance from the near field generator. For example, a typical noise floor level for eavesdroppers or adversaries may be determined, and the system may be designed to achieve low probability of detection at a defined distance from the adversary while maintaining effective jamming within a certain radius.

In addition, cryptographic techniques may be applied in creating the jamming information. For example, the jamming information may be selected to provide statistically similar properties as the useful information transferred by the near field generator to more effectively stop eavesdroppers from hearing the near field communications. For example, for digital data, the useful information may be passed through a cryptographic algorithm to obtain the jamming information. The jamming information may also be directly generated using a random data generator.

When useful information is encoded into the near field using a digital modulation technique (e.g., phase shift keying, amplitude shift keying, frequency shift keying, or combinations thereof) the near field varies according to modulation symbol timing. It may be helpful to couple 120 (FIG. 1) the jamming transmitter 116 to the near field generator 106 to enable synchronizing the modulation of the jamming signal 118 to the symbol timing of the near field generator 106. This coupling can be done in various ways to provide symbol timing information to the masking signal transmitter. For example, the near field generator can provide a timing signal to the jamming signal transmitter. As another example, the jamming signal transmitter may extract a timing signal from the modulated near field.

One exemplary embodiment may include a jamming signal that is decoupled from the near field generator. For example, an independent random noise generator can be used that has no knowledge of the data output or characteristics of the near field generator, as exemplified in FIGS. 2a and 2b. The random noise generator can be a wide bandwidth noise generator or the random noise generator can be tuned to specific electromagnetic spectrums.

Another exemplary embodiment may include a jamming signal transmitter that is not coupled to and is independent from the near field generator, but the jamming signal transmitter has the capability to detect and respond to the presence of and/or modulation type of near field communications. For example, the jamming signal generator may turn on the jamming signal when near field communications are detected and turn off the jamming signal when the near field communications are not active. In addition, the jamming signal generator may select an optimized masking pattern and bandwidth based on the near field communications type that is detected.

In one exemplary embodiment, the jamming signal can be uncorrelated to the information encoded in the near field signal when viewed in various dimensions of signal space. In other words, as is known in the art, signals can be viewed in time domain, frequency domain, code domain (for spread spectrum encoded signal), or viewed in vector spaces using defined sets of basis functions. One way to accomplish this is to generate the jamming signal using the same basic processes as the near field signal (e.g. modulation scheme, data format, data timing, etc) while randomizing the jamming signal in at least one dimensions relative to the near field signal to provide low or zero cross-correlation between the signals when measured in the at least one dimension. For example, randomizing data used to drive modulation of the signal can accomplish this randomization.

The present exemplary system for using the jamming transmitter has been described as jamming one other device, but the jamming transmitter can be used to jam the area surrounding two or more devices that are within near field communication range of one another. For example, a jamming transmitter can protect a wireless speaker microphone and a headset to which it is coupled, a wireless remote Push-To-Talk (PTT) switch, a wireless remote control module for volume or channel selection, a wireless data interface to a laptop or other data device.

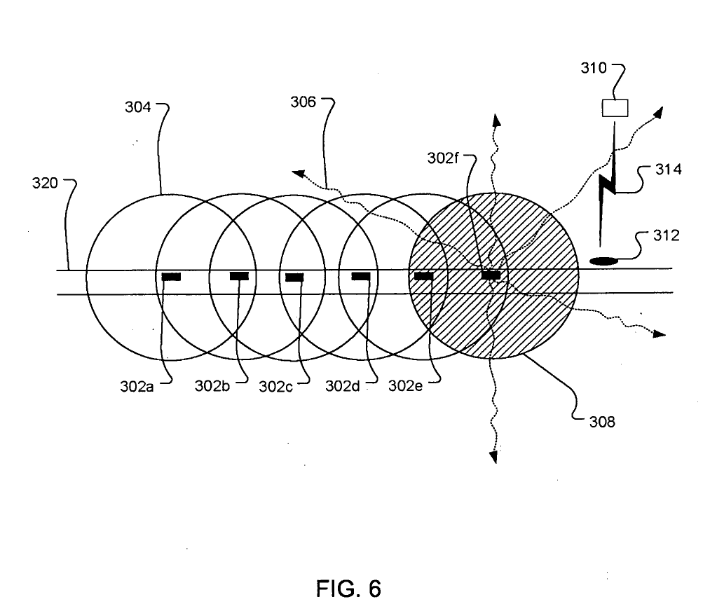

FIG. 6 illustrates a plurality of near field communications systems that are able to communicate with one another. These near field communications systems may be located within a moving vehicle, on a patrolling soldier, or on another platform 302a-f. When portable near field communications systems are used, then the entire network can be transported along a road 320 in a combat zone. There is a significant amount of risk when a combat unit is traveling due to remote explosive devices 312 that can be activated by wireless radio signals 314 or microwave communications sent from a wireless base station 310. These wireless communications may also be used to control robotic or radio activated combat devices that can be a danger to a combat group.

In such a situation, a jamming transmitter located in a vehicle 302f can create a jamming signal. The jamming signal can be stronger in a proximity 308 of the jamming device than farther away. The stronger jamming signal within the short range area can make it difficult for a near field communications system near the origin of the jamming signal to communicate with the other near field systems. In contrast, the longer range jamming signals 306 that are used to jam long distance RF and microwaves are less likely to affect the other near field communications devices in the network.

As a result, the present exemplary system can move and/or rotate the jamming signal between a number of different portable systems. In one exemplary embodiment, a jamming device can be located in each vehicle. The jamming can then rotate in a round-robin manner, a prioritized scheme or some other rotation scheme, where only one jamming transmitter at a time is active. Then the near field communications systems can be synchronized to communicate only when the jamming transmitters that are closest to the specific near field systems are turned off. For example, as illustrated in FIG. 6, near field communications devices located in proximity 304 may be synchronized to communicate since the jamming transmitter located in vehicle 302a is not active, whereas the near field communications devices located in proximity 308 may be synchronized to not communicate since the jamming transmitter located in vehicle 302f is active. Since one or more multiple jamming transmitters are always active, the protection for the entire system is maintained. Alternatively, the near field systems may detect whether the jamming signal is being broadcast at a defined strength level or the synchronization may be based on timing the near field communications.

In the configuration illustrated in FIG. 6 and in other networking configurations, some of the near field communications nodes are not able to communicate with other nodes that are too distant. For example, in FIG. 6, the first node in the transport column on the road cannot communicate with the last node using near field. Mesh networking can be used to transmit messages through intermediate nodes to other nodes. In this sense, every node in the mesh can act as a repeater or router to pass data through to the destination node. The mesh network can dynamically configure itself and maintain the necessary routing tables or information to make the mesh network effective when applied to near field magnetic induction communications.

In the past, one solution to allow communication in a jammed environment has been to turn off the jamming device and momentarily allow communications to occur. This strategy can be extremely dangerous because it does not provide any protection against an enemy remotely triggering hidden detonation devices. Alternatively, an open slot can be provided in the frequency spectrum to enable communications. This scheme has the same problem because even if frequency hopping is used to move the frequency around, the same clear window that is being used for communications can be used to detonate a hidden explosive or perform other communications. This is especially true if the enemy is intentionally transmitting on many frequencies in order to trigger a device. In practice, the use of a clear spectrum window is difficult to create anyway because of the intense noise created by jamming transmitters in the fundamental frequencies and harmonics which results additional harmonics and other spurious noise emissions. In contrast, the present exemplary system and method enable short and medium range communications (a few meters to a few thousand meters) without providing a clear transmission window to an enemy.

Of course, an enemy can also communicate using near field communications within the jammed area, but this requires an individual to be within visual range of the military force the adversary wishes to trigger a hidden explosive device against. If the trigger person is within visual range of the military force, then the trigger person can more easily be eliminated.

In another exemplary embodiment, two or more jamming transmitters in the group may be jamming at any given time to increase jamming effectiveness. When multiple jamming transmitters are active then the near field communications can rotate to communicate between near field systems that are not located near jamming radios. For example, several jamming transmitters can be turned on and only one or two will be left off to allow communications between selected near field devices.

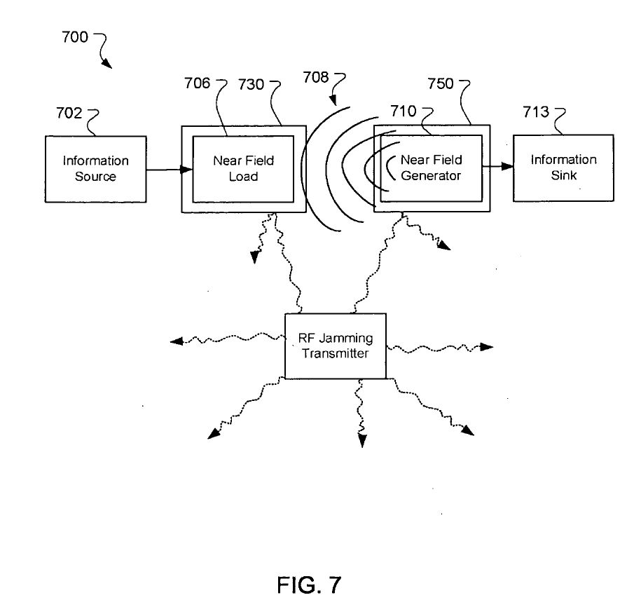

FIG. 7 illustrates another exemplary embodiment of a near field communications system 700. In this configuration, the near communications field system 700 may exchange information using a near field generator 710 which acts as a near field generator to generate a magnetic or electric field 708. An information source 702 can then vary a load 706 on the generated field 708 which correlates to the information to be exchanged. The near field generator 710 can include modules to detect modulation changes and decode the information encoded in the magnetic field 708 from the information source 702 in order to provide an information output to an information sink 713. The near field generator 710 and load 706 can also include one or both of shields 730 and 750.

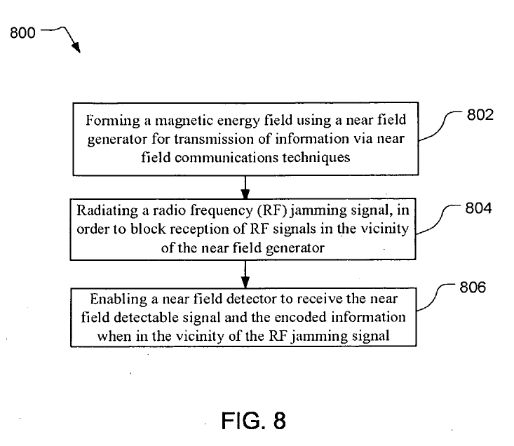

A method for enhancing security of a near field communications system is described in conjunction with a flowchart illustrated in FIG. 8. The method, shown generally at 800, can include forming a magnetic energy field using a near field generator for transmission of information via near field communications 802. For example, the energy field may be a magnetic field. Characteristics of the energy field may be varied to encode information thereon. For example, the energy field may be varied in field strength, orientation, etc. The energy field may be varied according to a carrier signal, with characteristics of the carrier signal (e.g. frequency, phase, amplitude, and combinations thereof) varied to encode the information. For example, a carrier signal can have a frequency of 100 kHz, 13.56 MHz, or other frequencies. In general, higher carrier signal frequency provides a shorter near field range.

The method also includes radiating a RF jamming signal, in order to block reception of RF signals in the vicinity of the near field generator 804. For example, as described above, a jamming signal can be produced by transmitting RF signals. This jamming signal is configured to make it difficult for others in the vicinity of the near field communications system to communicate while those using the near field communications will be able to maintain communications. Furthermore, the jamming signals can block RF signals that may be used to detonate hidden bombs, IEDs, control Unmanned Aerial Vehicles (UAVs), control robotic vehicles, and direct similar offensive RF devices. This allows a remotely controlled robot to be sent into a hazardous combat environment, where the propagated EM waves are being jammed. In the past, the jamming signal would have disabled the robot, but with the near field communications system any enemy signals can be jammed while the robot performs its bomb clearing job or other jobs.

The method can also include enabling a near field detector to receive the near field detectable signal and the encoded information when in the vicinity of the RF jamming signal 806. The jamming signal can interfere with techniques for eavesdropping on the near field system, making it difficult for an eavesdropper to decode the information while still allowing for near field communications. The jamming signal may be slightly higher in signal level as compared to the near field magnetic communications system, which can help hide the information without unacceptable increases in the ability for an adversary to detect the jamming signals.

The use of a near field communications system in this disclosure has been described as a short range system but this is relative term that compares near field systems to existing longer range RF systems. More specifically, the use of the term short range refers to the near field region of the electromagnetic radiation which is generally equal to or less than

$$\frac{λ}{2 π}$$

(the wavelength over 2 pi). For example, there are communication applications such as mining and short range systems where the near field communications can be extended to hundreds of meters by reducing the carrier frequency and increasing the wavelength. For example, a carrier frequency of 100 kHz may be used to generate near fields with a range of over 400 meters.

While the present exemplary system and method has been described to address a jammed environment, certain exemplary embodiments of the present invention are equally applicable to an environment experiencing a high field strength, regardless of the cause.

To summarize, the present exemplary system and method enable wireless communications in an environment where a jamming signal in the RF or microwave bands is being transmitted. By the techniques described, it is possible to wirelessly communicate in a high field strength or jammed environment, even when the EMI signals are at or near the frequency of the near field magnetic communications system. Continued electronic communication in such jammed environments has not been possible with previously known RF technologies. Such exemplary embodiments may be particularly useful for hands-free headsets in military, law enforcement, security, public service, remote robotics, enabling and disabling remote sensors, unmanned vehicles, and other applications. Other applications can include the transfer of data between computing and communication devices over a short distance, the communication of signals such as stopping and starting other devices, or providing a single signal to set a defined state.

It is to be understood that the arrangements described herein are only illustrative of the application for the principles of the present invention. Numerous modifications and alternative arrangements can be devised without departing from the spirit and scope of the present invention as defined by the appended claims and their equivalents. While the present invention has been shown in the drawings and fully described above with particularity and detail with reference to certain exemplary embodiments thereof, it will be apparent to those of ordinary skill in the art that numerous modifications can be made without departing from the principles and concepts of the invention as set forth herein.

What is claimed is:

1. A near field communications system, the system comprising:
a near field generator configured to generate a near field detectable signal comprising information;
a near field detector configured to receive the near field detectable signal and output the information; and
an Electro-Magnetic (EM) Radio Frequency (RF) jamming transmitter configured to radiate an EM RF jamming signal, in order to jam reception of EM RF signals in the vicinity of at least one of the near field generator and near field detector.

2. The system as in claim 1, wherein the near field generator and near field detector operate a semi-static magnetic field at a frequency within the bandwidth of the EM RF jamming transmitter.

3. A method for a near field communications system, the method comprising:
forming a magnetic energy field using a near field generator for transmission of information via near field communications;
radiating an Electro-Magnetic (EM) Radio Frequency (RF) jamming signal, in order to jam reception of EM RF signals in the vicinity of at least one of the near field generator and a near field detector; and
enabling the near field detector to receive the information via the near field signal when in the vicinity of the EM RF jamming signal.

4. A near field communications system, the system comprising:
a near field generator configured to generate a near field detectable signal comprising information;
a near field detector configured to receive the near field detectable signal and output the information;
an Electro-Magnetic (EM) Radio Frequency (RF) jamming transmitter configured to radiate an EM RF jamming signal, in order to jam reception of EM RF signals in the vicinity of at least one of the near field generator and the near field detector; and
an EM shield surrounding the near field generator to block EM frequencies from interfering with operations of the near field generator.

5. The system as in claim 4, wherein the EM shield is configured to block EM RF.

6. The system as in claim 4, wherein the EM shield is a Faraday cage.

7. A near field communications system, the system comprising:
a near field generator configured to generate a near field detectable signal comprising information;
a near field detector configured to receive the near field detectable signal and output the information;
an Electro-Magnetic (EM) Radio Frequency (RF) jamming transmitter configured to radiate an EM RF jamming signal, in order to jam reception of EM RF signals in the vicinity of at least one of the near field generator and the near field detector; and
an EM shield surrounding the near field detector to block EM frequencies from interfering with operations of the near field detector and to allow magnetic fields to pass through the EM shield.

8. The system, as in claim 7, further comprising a second EM shield surrounding the near field generator to block EM frequencies from interfering with operations of the near field generator and to allow magnetic fields through the EM shield.

9. A near field communications system, the system comprising:
a near field generator configured to generate a near field detectable signal comprising information;
a near field detector configured to receive the near field detectable signal and output the information; and
an Electro-Magnetic (EM) shield surrounding the near field detector to block EM frequencies from interfering with operations of the near field detector.

10. The system as in claim 9, further comprising a second EM shield surrounding the near field generator to block EM frequencies from interfering with operations of the near field generator.

11. The system as in claim 8, wherein the near field generator has a plurality of diverse antennas.

12. The system as in claim 11, further comprising a shield surrounding each antenna of the plurality of diverse antennas for the near field generator.

13. The system as in claim 8, wherein the near field detector has a plurality of diverse antennas.

14. The system as in claim 11, further comprising a shield surrounding each antenna of the plurality of diverse antennas for the near field detector.

15. The system as in claim 8, wherein the shield is a Faraday cage.

16. The system as in claim 8, wherein the EM shield is designed to reduce near field loss as near field communications pass through the EM shield.

17. The system as in claim 16, wherein the EM shield is designed to reduce magnetic field loss from eddy currents in the EM shield as near field communications pass through the EM shield.

18. The system as in claim 16, wherein the EM shield includes apertures to reduce magnetic field loss from eddy currents and to maximize EM attenuation.

19. The system as in claim 16, wherein the EM shield includes conductive non-magnetic material in a non-conductive matrix to reduce magnetic field loss from eddy currents and to maximize EM RF attenuation.

20. The system as in claim 8, further comprising a near field antenna using antenna material for at least one of the near field generator and the near field detector that shields from EM interference.

21. The system as in claim 8, further comprising a near field antenna having an antenna shape for at least one of the near field generator and the near field detector that shields from EM interference.

22. The system as in claim 8, further comprising a near field antenna having antenna windings for at least one of the near field generator and the near field detector configured to shield from EM interference.

23. A near field communications system, the system comprising:
a near field generator configured to generate a near field detectable signal comprising information;
a near field detector configured to receive the near field detectable signal and output the encoded information; and
a defeat structure configured to reduce Electro-Magnetic (EM) frequencies from interfering with operations of at least one of the near field generator and the near field detector.

24. The system, as in claim 23 wherein the defeat structure is a shielding device.

25. The system, as in claim 24 wherein the shielding device is a Faraday cage.

26. The system as in claim 24, wherein the shielding device is designed to reduce near field loss.

27. The system as in claim 24, wherein the shielding device is designed to reduce magnetic field loss from eddy currents.

28. The system as in claim 24, wherein the shielding device includes apertures to reduce magnetic field loss from eddy currents and to maximize EM Radio Frequency (RF) attenuation.

29. The system as in claim 24, wherein the shielding device includes conductive non-magnetic material in a non-conductive matrix to reduce magnetic field loss from eddy currents and to maximize EM Radio Frequency (RF) attenuation.

30. The system as in claim 23, further comprising using an antenna for at lest one of the near field generator and the near field detector having antenna material that shields from EM interference.

31. The system as in claim 23, further comprising using an antenna for at least one of the near field generator and the near field detector, having an antenna shape that shields from electromagnetic interference.

32. The system as in claim 23, further comprising an antenna for at least one of the near field generator and the near field detector, the antenna having antenna windings that shield from EM interference.

33. The system as in claim 23, further comprising near field antennas for at least one of the near field generator and the near field detector oriented in more than one plane.

34. The system as in claim 23, further comprising near field antennas oriented in only one plane.

35. The system as in claim 23, further comprising near field antennas for at least one of the near field generator and the near field detector having a shielding device surrounding each individual antenna.

36. The system as in claim 23, further comprising near field antennas for having a shielding device surrounding a grouping of antennas.

37. The system as in claim 23, wherein the defeat structure is an antenna shape optimized for magnetic field reception and reduction of EM Radio Frequency (RF) reception.

38. The system as in claim 23, wherein the defeat structure includes an antenna material that is insensitive to EM fields and sensitive to magnetic fields.

39. The system as in claim 23, wherein the defeat structure includes shielding around an antenna winding.

40. A near field communications system, the system comprising:
a near field generator configured to generate a near field detectable signal; and
a near field load configured to inductively couple with the near field detectable signal and vary a load which correlates to information to be exchanged, wherein the near field generator can detect the information by monitoring the load created by the near field load;
wherein at least one of the near field generator and the near field load receive an Electro-Magnetic (EM) Radio Frequency (RF) jamming signal configured to jam reception of EM RF signals.

41. The system as in claim 40, further comprising an EM RF jamming transmitter configured to radiate the EM RF jamming signal, in order to jam reception of EM RF signals in the vicinity of at least one of the near field generator and the near field load.

42. The system as in claim 40, further comprising an Electro-Magnetic (EM) shield surrounding the near field generator to block EM frequencies from interfering with operations of the near field generator.

43. The system as in claim 40, further comprising an Electro-Magnetic (EM) shield surrounding the near field load to block EM frequencies from interfering with operations of the near field load.

44. The system, as in claim 42 wherein the EM shield device is a Faraday cage.

45. The system as in claim 42, wherein the EM shield is designed to reduce near field loss.

46. The system as in claim 42, wherein the EM shield is designed to reduce magnetic field loss from eddy currents.

47. The system as in claim 42, wherein the EM shield includes apertures to reduce magnetic field loss from eddy currents and to maximize EM Radio Frequency (RF) attenuation.

48. The system as in claim 42, wherein the EM shield includes conductive non-magnetic material in a non-conductive matrix to reduce magnetic field loss from eddy currents and to maximize EM Radio Frequency (RF) attenuation.

49. The system, as in claim 43 wherein the EM shield device is a Faraday cage.

50. The system as in claim 43, wherein the EM shield is designed to reduce near field loss.

51. The system as in claim 43, wherein the EM shield is designed to reduce magnetic field loss from eddy currents.

52. The system as in claim 43, wherein the EM shield includes apertures to reduce magnetic field loss from eddy currents and to maximize EM Radio Frequency (RF) attenuation.

53. The system as in claim 43, wherein the EM shield includes conductive non-magnetic material in a non-conductive matrix to reduce magnetic field loss from eddy currents and to maximize EM Radio Frequency (RF) attenuation.

54. The system as in claim 40, further comprising using an antenna for at lest one of the near field generator and the near field load having antenna material that shields from EM interference.

55. The system as in claim 40, further comprising using an antenna for at least one of the near field generator and the near field load, having an antenna shape that shields from EM interference.

56. The system as in claim 40, further comprising an antenna for at least one of the near field generator and the near field load, the antenna having antenna windings that shield from EM interference.

57. The system as in claim 40, further comprising near field antennas for at least one of the near field generator and the near field load oriented in more than one plane.

58. The system as in claim 40, further comprising near field antennas oriented in only one plane.

59. The system as in claim 40, further comprising near field antennas for at least one of the near field generator and the near field load having a shielding device surrounding each individual antenna.

60. The system as in claim 40, further comprising near field antennas for having a shielding device surrounding a grouping of antennas.
